(19) United States
(12) Patent Application Publication
(10) Pub. No.: US 2003/0130893 A1
(43) Pub. Date: Jul. 10, 2003

(54) Systems, methods, and computer program products for privacy protection

(75) Inventor: Bennie L. Farmer, Ann Arbor, MI (US)

Correspondence Address: HAHN LOESER & PARKS, LLP, TWIN OAKS ESTATE, 1225 W. MARKET STREET, AKRON, OH, 44313, US

(73) Assignee: Telanon, Inc.

(21) Appl. No.: 10/291,196

(22) Filed: Nov. 8, 2002

Related U.S. Application Data
(63) Continuation-in-part of application No. 09/638,177, filed on Aug. 11, 2000.
(60) Provisional application No. 60/337,827, filed on Nov. 8, 2001.

(51) Int. Cl. G06F 17/60

(52) U.S. Cl. 705/14

(57) ABSTRACT

A systems and method of transmitting or communicating unique data from a unique user through a communications and/or computer network to a third party, wherein the third party has no method of determining the personal-identifying information (PII) of the unique user upon receiving the data. The invention provides privacy protection and location for communication of data, voice or other information via a communications network, for providing various services related to telematics communications and other location-based services.

This application is a continuation in part of U.S. application Ser. No. 09/638,177 filed Aug. 11, 2000, which is hereby incorporated by reference, this application also claims the benefit of U.S. Provisional Application Serial No. 60/337,827 filed Nov. 8, 2001 which is hereby incorporated by reference.

### TECHNICAL FIELD

The present invention relates generally to systems and methods of transmitting or communicating unique data from a unique user through a communications and/or computer network to a third party, wherein the third party has no method of determining the personal-identifying information (PII) of the unique user upon receiving the data. The invention provides privacy protection and location for communication of data, voice or other information via a communications network, for providing various services related to telematics communications and other location-based services. In one aspect, the present invention involves the transmission of unique data over a communications network, whereby identification information relating to a unique user is replaced with a randomly generated identification code. As a result, the data set is anonymized and any subsequent processing of the data set by a third party will be done anonymously. In another aspect, the invention may be used to anonymize voice information. The system and methods protect the identity of the users of the communication system and prevent a third party from determining what specific party generated the anonymized data, or other personal identification information on the user.

### BACKGROUND OF THE INVENTION

Currently, in telematics systems and other systems, data are communicated to a central location wirelessly and/or via a combination of transmission lines. Data communicated can be of a variety of forms, including but not limited to text, voice, image or other data, and for a variety of purposes, including but not limited to consumer services, providing data such a map or location data, emergency alerts, and a myriad of other possible purposes. The data is communicated or transmitted to a third party via a computer network for subsequent processing or use, and generally for a variety of situations, the data can be related to the sender via some form of identification tag, such as for targeted marketing. Once the third party receives data for processing, the third party is able to locate the identifying tag and determine who the data relates to and possibly where the data was generated. For emergency situations for example, the system can be used to communicate the user and location of the user to allow assistance to be automatically summoned. In many other situations, due to privacy concerns, it would be advantageous to have any personal information communicated and analyzed anonymously. This lowers the risk that the third party will be able to link the owner of the data to the data itself, and protects the user from unwanted identification for accessing and using various services or other aspects of the telematics or other systems. Therefore, it would be advantageous to provide the ability to anonymize data for selected communications.

### SUMMARY OF THE INVENTION

The present invention is directed to systems and methods for providing privacy protection for data or information communicated from a vehicle, for providing services such as personalized insurance services to a user. Additionally, the invention provides privacy protection for telematics communication or other wireless location based services to be selectively provided to a user.

These and other aspects of the present invention are provided by a method for protecting the privacy of data communicated from a vehicle comprising the following steps: aquiring at least one data element within the vehicle; removing any personal identification information from the at least one data element; transferring the at least one data element via wireless communications to at least one receiver not located on the vehicle.

These and other aspects of the present invention are also provided by a system for protecting the privacy of data communicated from a vehicle comprising: a communications system in association with the vehicle, the communications system being coupled to at least one data generating system associated with the vehicle to receive at least one data element selected from the group consisting of an operating state of the vehicle, status of the driver, location of the vehicle, an action of the driver during a selected period, external environment or combinations thereof; wherein the communications system is operated to selectively transmit the at least one data element from the communications system to a processing system, wherein the processing system removes personal identification information from the at least one data element, wherein the processed information is transmitted to at least one interested supplier of a product or service.

Other aspects of the methods and systems according to the invention will become clear upon a reading of the detailed description in conjunction with the drawings.

### SUMMARY OF THE DRAWINGS

FIG. 1 is a schematic illustration of the privacy protection system according to the invention.

FIG. 2 is a flowchart illustrating the process of anonymizing generated data.

FIG. 3 is a flow chart that illustrates the use of relating multiple anonymous identification codes that correspond to multiple sets of generated data.

FIG. 4 is a flow chart that illustrates the function of a variable size buffer for further anonymizing data.

### DETAILED DESCRIPTION

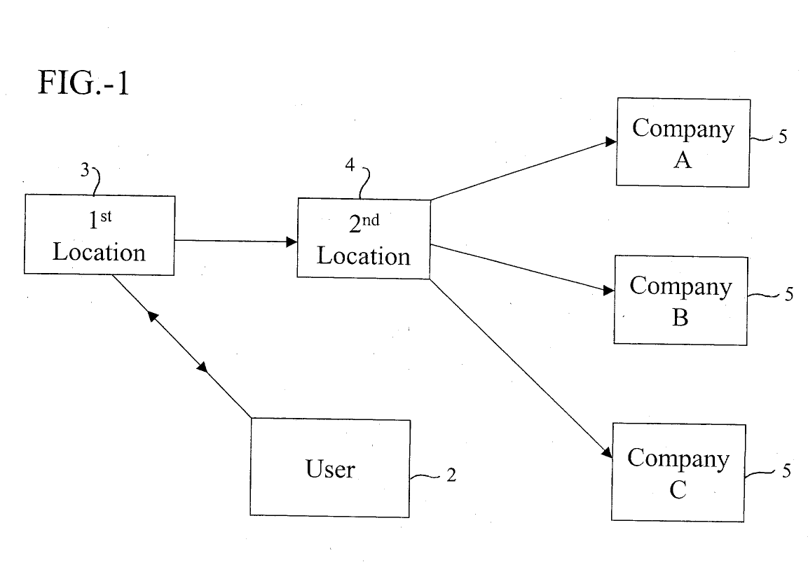

The invention is directed to privacy protection in the use of communication systems and services accessed through such systems. In systems and methods, such as described in U.S. patent application Ser. No. 09/633,127, which is hereby incorporated by reference, wireless communication from a vehicle is provided to allow the acquisition of location and operational characteristics of the driver as an example, for tailoring insurance products to the specific use and risks for individual drivers. Although it is desirable to provide information to allow such assessments, it also presents privacy issues with respect to use of such information. It is therefore one aspect of the invention to provide privacy protection for data generated or received from a vehicle for this type of system. Further, in a telematics system, the use of communication devices may allow the user to access location based services or other information or services, and again privacy issues are apparent. Similarly, users can access information or services using cell phones or other wireless communication devices, wherein identifying information is normally supplied with the communication to verify the user as a customer, again raising issues of privacy when combined with data on the location of the caller. The invention provides privacy protection for telematics use as well as with usage of a cell phone or the like. Further, the invention provides the ability to modify the level of privacy protection to fit the user's desires. Thus, in a telematics system or other mobile devices with wireless communication capabilities, the user may wish to identify goods or services based upon location and/or based upon their own preferences and interests. Marketing profiles can be developed to represent the individual tastes and preferences of a user, and such profiles can then be used to provide personalized information regarding goods/services or the like. Such a user may not be overly concerned about issues of privacy relating to their marketing profile, and a lesser level of privacy protection may be suitable. As will be described in more detail hereafter, a level of privacy protection which may be suitable may utilize the methods and systems of the present invention to provide a customized marketing system for a known user depending on known user preferences. At the same time, the user may wish some level of privacy protection, and the present invention provides for anonymizing certain communications. For communications using equipment that will provide personal identifying information relating to the user, the invention provides for the communication to be directed to a first location, where the customer PII will be directed, such as the name of the user, the equipment identification code or the like. In FIG. 1, a user 2 communicates to a first location 3 via any suitable communication device such as a telephone, cellular telephone, wireless communication device or the like, however it is also contemplated that the first location 3 could be located in the vehicle wherein the connection would be a direct connection or direct voice input, or other suitable connection for an in-vehicle unit. The communication is then stripped of all PII at the first location 3 and can be forwarded to a second location 4 for processing and/or use of the information. In the use of vehicle information for insurance assessment purposes for example, the information compiled at the second location 4, can be further anonymized and forwarded to one or more insurance companies or other providers of goods or services represented at 5 for preparing a quote for insurance to the user. Alternatively, the information compiled at the second location 4 may be anonymously forwarded to one or more suppliers of goods and/or services to respond to the user. Depending on the wishes of the user, information could also be provided to such suppliers regarding the personal marketing profile or preferences of the user. At the second location 4, the user could select to communicate profiles by demographics so as to remain anonymous, or alternatively could provide an individual profile for more personalized marketing of goods/services.

As an example of an embodiment of the invention: The customer data file maintained at Location 1 may have a “flag” set for each vehicle to indicate the type of data that will be transmitted—whether real time or “batch” file, how frequently the location data points were taken, whether encrypted data contains customer ID info, and if so, how to locate and remove it without affecting Location 2's ability to decrypt the remaining data it receives. That “flag” will be transmitted to Location 2 along with the other data, to indicate the nature of the data in the transmission. Thereafter location 2 may take the “flag” into account in several ways. Since there are combinations of factors indicated by the “flag” which may effect processing of data, such as if the remaining data received at Location 2 cannot be decrypted due to loss of data at Location 1, Location 2 will base not only the decryption method it utilizes on that “flag”, it will also know whether it signifies that customer ID information is contained in the encrypted data, and whether the beginning/end data removal step has already been performed. Based on the “flag”, it will utilize the appropriate decryption approach, remove any customer ID information without saving it, and also perform the beginning/end location data removal (using pseudo-random values between designated limits as an example) if that step has not already been performed at Location 1. For example, real-time communication of data will likely lend itself to allowing Location 1 to perform the beginning/end data removal process described before, since any encryption method would be based on no more than the “message” being transmitted for a single data event. However, at the other extreme, the “store and send batch data later” approach, might utilize an encryption approach based on the entire file in which case the removal of any data might prevent the rest of the file from being decrypted. At Location 2 this may require decryption of the entire “batch” file, and then remove any customer ID information contained within, plus perform the beginning/end location data removal step described earlier as being done at Location 1. This modified approach, using the “flag” at Location 1, will provide the highest level of privacy protection possible for each type of data transmission. At best, no customer ID information nor beginning/end location data ever reach Location 2. At worst, one or both types of confidential data reach Location 2 but are not stored, even temporarily—they are recognized as such and deleted from the data before the rest of the information is stored. There may be situations in which the beginning/end removal of location data before any processing by the insurance company software would affect the outcome, since levels of vehicle security may be assigned based on specific locations where the Vehicle is parked. In that case, the beginning/end data deletion step may not be performed at Location 1 even if it could otherwise be without damaging the ability of Location 2 to decrypt the remaining data. Even so, the beginning/end location data would not be transmitted to any insurance companies, to avoid it being de facto identification of the customer; instead, at least that portion of each insurance company's processing would be performed on that “parked location” data separately from the remaining data, either at Location 2 or by separate transmission to the insurance companies and with the results returned. Then, the beginning/end data removal step would be performed by Location 2 and the remaining data stored along with the results of the insurance company “parked location” analysis. In this way, the results of the analysis of the precise parking locations is known without having both those precise “parking” locations plus additional location data revealed to any outside party together.

Therfore objectives of the invention may include: a) allowing privacy-protection plus benefit of an approach for offering customers potential insurance premium discounts; and b) creation of “floating car data” databases for analytical purposes with no data captured from customers vehicles that can be utilized for accident reconstruction purposes unless those customers have chosen an “accident reconstruction” option with their current insurer (and presumably be receiving an additional premium discount).

With respect to accident reconstruction options: Location 1 may have an additional function for customers electing an AIR option with their current insurers, as follows. Not only would the A/R option flag be noted and the “end” location data removal step skipped in the case that an “accident reported” message also received within the chosen time period before that data would be deleted—for real-time data transmission cases, there may also be a separate A/R buffer created into which the most-recent data specifically identified as A/R-related are stored. up to some Z amount of data based on storage size or elapsed time. Then, if the “accident reported” message is not received within the chosen time period, that entire buffer is erased (and the “end” location will also be removed at the appropriate time from the other data being collected). However, if the “accident reported” message is received within the chosen time, the entire contents are transmitted to both the current insurer along with the customer and vehicle IDs, and to Location 2 (without the customer or vehicle IDs). This is only done if the customer has previously accepted the A/R option with the agreement that this will be done in the case of a reported accident involving that customer” vehicle.

The present invention also provides for privacy protection for voice communications wherein the PII related to users may be their voices, as speaker recognition methods can be used to create a unique voice print for reliably identifying the speaker in future voice communications. To prevent use of voice print information to identify a speaker, voice disguising systems and methods may be provided to ensure anonymous use of location based services. At the same time, the voice print PII may be used at the first location 3 to allow the user to authorize providing an individual profile along with a communication for directed marketing to the user. Use of a voice print to identify users accessing information and/or services via telephone or the like would then allow a user to specify the level of privacy protection, and also to prevent others from creating a personal marketing profile related to a particular user. Further, the voice print PII could be used to allow multiple users of the same system to be identified, with each user able to specify the level of privacy protection suitable for them.

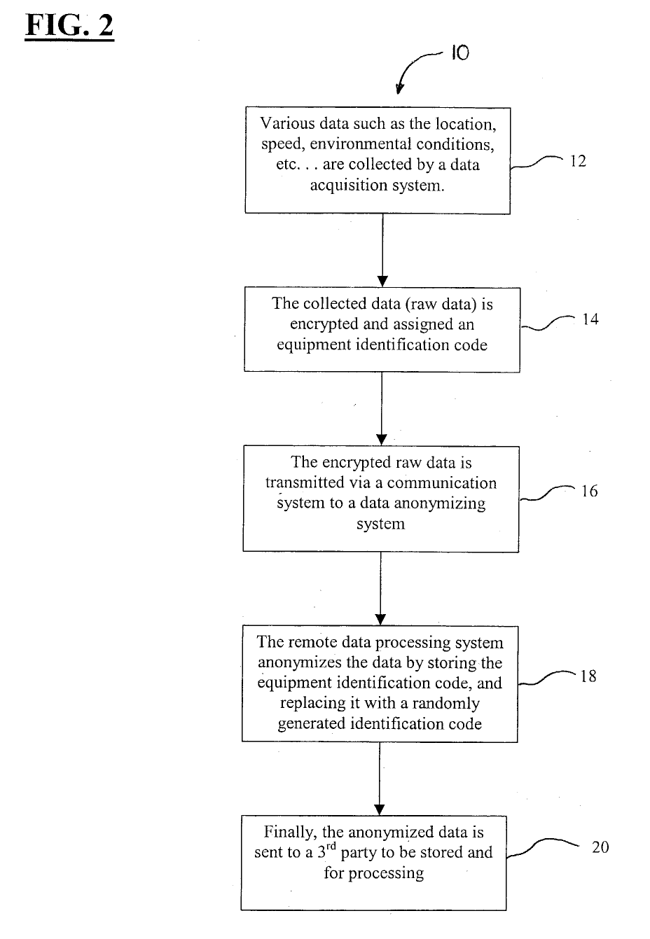

It should thus be evident that the invention can be useful to provide privacy protection for many different applications and systems. Although the description will be directed at more specific embodiments of the invention, this should not be construed as limiting the invention. Turning to FIG. 2, a privacy protection system 10 for use in anonymizing data, such as may be generated from a telematics system in a vehicle or other communication system is shown. The present invention 10 includes a data acquisition system for collecting raw data from a communication system. The data may be of a variety of forms, such as relating to the location from which the data was generated. With location data communicated, a service provider could in turn provide information to the user relating to goods or services of interest in the vicinity of the user. Other data may include vehicle related data, such as operational parameters, speed, direction, related environmental conditions that the vehicle is negotiating, or any other similar type of data that is needed to be collected 12. Other types of data may comprise voice data to access other information available over the computer network, which may be a global network such as the Internet.

Once the desired data or other information is collected, the raw data is encrypted 14 using any variety of methods known in the art. As an example, in association with the data, there may be identification information, such as an equipment identification code which may be assigned by the data transmission equipment such as a cellular phone, modem or other data transmission system to identify the user that is transmitting data via the data transmission system 14. Other identification information may be voice data used for authentication purposes or any other type of identifying information communicated with the data or determined from the data.

In the example of a data transmission system, which attaches an equipment identification code to the raw data, the raw data are transmitted to an independent data anonymizing system 16. Upon receipt of the raw data and equipment identification code, the anonymizing system stores the equipment identification code. The system then anonymizes the raw data by replacing the equipment identification code with a randomly generated “anonymous” identification code, which is assigned to the raw data 18. However, the equipment identification code is related to the anonymous identification code so that when the raw data is processed by an independent organization it can be linked by the anonymizing system back to the specific vehicle or motorist who created the data. Normally, a data-transmitting device attaches an equipment identification code to the transmitted data so that the transmission system can authenticate that the user of the transmission service is a valid registered user. However, by using an independent anonymizing system that replaces the equipment identification code with a randomly generated identification code the privacy of the collected raw data and identity of the motorist is increased. After the randomly generated identification code is assigned to the encrypted raw data, the data anonymizer transmits the data to an independent third party for analysis, processing, and storage 20. Here, the raw data is decrypted, and stored in an anonymous database. Because this anonymous database has only the randomly generated or “anonymous” identification code and not the equipment identification code, the third party that is archiving the anonymous data is severely limited in its ability ascertain the identity of the party who created the data.

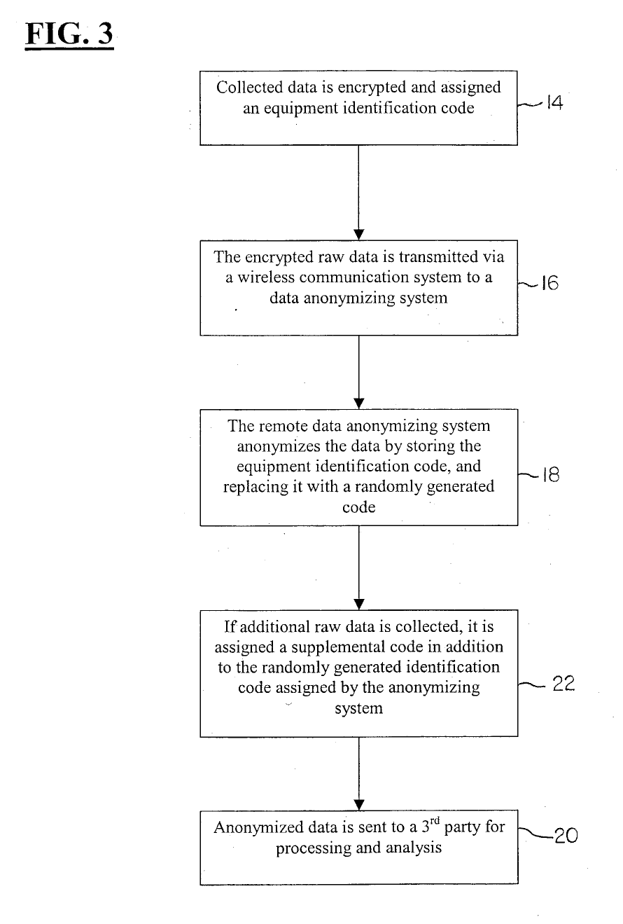

An additional embodiment of the present invention 10 is illustrated in FIG. 3, which illustrates the ability of the present invention 10 to relate multiple random/anonymous identification codes. This feature is beneficial when multiple sets of data are collected during a discrete time period. By relating the data sets to each other for a specific reporting period, entities will receive a more accurate description of the users activities for offering various goods or services, as well as facilitate the billing process for any third party services that the customer may subscribe to. As an example, entities such as insurance companies, and the like, could receive more comprehensive information related to a motorist's driving habits. Also, the aggregate data may be used to generate reports for the user to see the information being forwarded to the insurance company or the like. Aggregate data may also be used to create demographic or other compiled information for use by the third party. To relate the sets of data, the present invention 10 uses the same initial random/anonymous identification code for all individual raw data sets that are anonymized for a specific period of time, such as one month. To distinguish among the multiple data sets that contain have a common random/anonymous code which have been transmitted within a specific period of time, a supplemental code is added to the random/anonymous code assigned to each successive data set that is transmitted during the period.

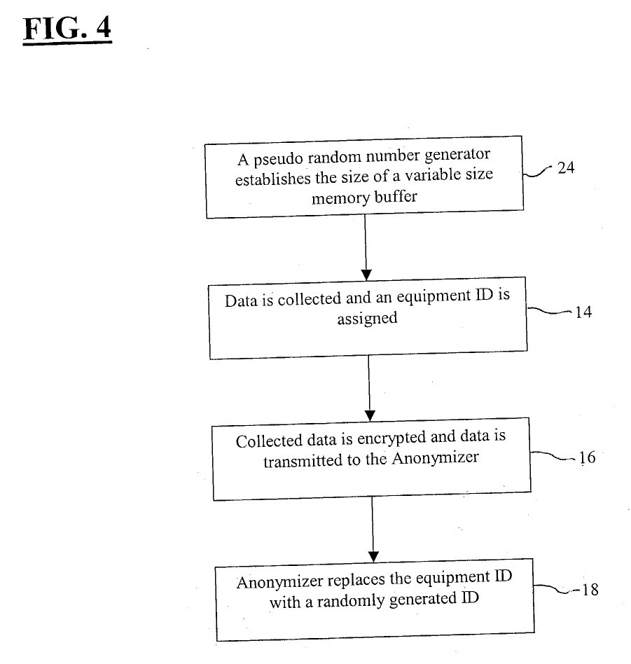

FIG. 4 refers to the present invention's 10 use of a variable size data buffer to provide additional privacy protection for the mobile user such as a motorist and the generated data. When a user of the present invention 10 proceeds to travel in their vehicle or the like, location data may be captured and sent. The information could be generates from an in-vehicle device or a separate device such as a cell phone or the like. It should be evident that the location information itself, although rendered anonymous by the present systems and methods described above, may still be used to ascertain the identity of the vehicle driver or user that is originating the data. This is due to the fact that the vehicle's origin location data are being transmitted, thereby allowing one to ascertain the initial location of the party's vehicle and then being able to determine the probable house, work or other PII related to these locations. This in turn would potentially allow a third party with access to the location information to identify the user. However, the present invention 10 eliminates the potential of using the anonymous location data to locate the vehicle through the use of a variable size data buffer 24. Additionally, each time the present invention 10 is first initiated for use, the variable buffer using a random number generator, or the like randomly pre-establishes the amount of data that the variable buffer is capable of storing. As location, speed, time, or other data are initially collected at the beginning of the vehicle's trip, the acquired data is stored in the buffer's memory. After the buffer is filled, the data contents of the buffer is deleted from the buffer's memory and the data is never transmitted to the anonymizing system or to the anonymous database. By deleting the contents of the buffer, the location data that was collected at the beginning of the vehicle's trip is not made known to any party that could later receive the data for processing. Therefore, the process of using the transmitted data to reconstruct or trace the vehicle back to a certain beginning point is substantially prevented.

Additionally, to prevent the ascertainment of the ending location of a vehicle by reconstructing the vehicle's “trip,” the present invention 10 randomly allocates a buffer size at the end of the “trip”, and then deletes the data contents that is stored in the allocated buffer before it is transmitted. This provides the motorist as well as the vehicle's data additional anonymity, so that location data from a common route cannot be used by third parties that process the transmitted data to ascertain the destination of the vehicle's route. As data is being transmitted, data is stored in the variable buffer. If the accident reconstruction option is not invoked, the contents of the buffer is sent to the anonymizer to replace the equipment identification code with the randomly generated code. However, it is also contemplated that the present invention 10 have the option of transmitting the buffer's contents if a save condition option is selected by the motorist or other individual prior to the beginning of the “trip.” An accident reconstruction data identification instruction may also be initiated to capture data in the event of an accident or emergency. Evidence of the presence of the vehicle at the scene of an accident is also communicated within a short time following an accident, which may be used to provide assistance. By saving and transmitting the contents of the buffer, in the event of an accident, it allows entities such as an insurance company to have additional supportive evidence that includes speed, location, time, or other the like to protect its insured motorist. Further, the invention allows an in vehicle communication device to be used for automatic crash notification (ACN). In an embodiment, ACN is provided by means of location data and/or other vehicle systems, which are monitored to provide data to an insurance company or the like. Using location and/or speed data, a typical deceleration of the vehicle can be monitored to detect an accident. Alternatively, an accelerometer could be provided in association with the vehicle to monitor for an accident. Other means to detect an accident, such as a sound detector that monitors the operation of the vehicle to detect sounds of an accident, deployment of the airbag or the like, may be used to provide ACN.

In other aspects of the invention, voice data may be used to allow easy and effective access to a wide variety of information available on the Internet as an example. The voice information may be used for “speaker recognition” by a third party wherein the user is recognized without having a relationship with the third party. Alternatively, voice may be used by a third party for “speaker verification” where the user has engaged the third party to acquire services, such as through a voice portal or the like. The so-called “voice portal” development companies are able to use receive and process voice data received from any telephone, cell phone or other suitable devices. Users can access and utilize a variety of information and services via the voice portal for a variety of purposes. As part of this technology, the voice information may be analyzed such that a caller's voice can be uniquely identified to distinguish it from others, thereby creating a voice ID. This ability allows authentication of the user by creating and storing a “voice print” for known customers and using voice print to uniquely ID a user. The unique voice ID could be used to authenticate the identity of a caller, using a one to one comparison of a caller's voice to a created voice ID. Alternatively, a voice print database could be created to compare a caller's voice to, allowing a user of known communication equipment to prevent association of their identity to third parties relating to their personal transaction information. Such information can be associated only with a voice ID to maintain anonymity. Once identified as a bona fide customer, the user may then access information or services during the call. With such technology, any instances in which a voice call is made by an individual who is identifiable (either from information provided by the individual during the call, or from a personally-identifiable information (PII) such as caller ID, equipment ID, or static IP address in the case of voice-over-IP telephony) would allow the creation of a voice print for that person along with PII about him/her. With that data, then the individual's voice itself, when transmitted during a communication, can be used to link via the stored voice print to PII. So the voice ID technology along with collection of voice samples and PII allows individuals' voices themselves to become a PII. The voice ID technology would further allow profiling of a user once identified, such as to provide a personalized marketing profile for accessing desired goods/services through telematics services. Using a voice ID to create a “voice print”,from an individual's voice, the voice can then be used as the sole identifier of the individual for consumer marketing profile purposes, and can be used in both the wired Internet world or for wireless location-based marketing using text messages or other information which is transmitted to a consumers' wireless device. In this way, voice data can be used to allow profiling of demographic, psychographic, geographic or other information relating to a user. Information from a user could be gathered from numerous sources, including the consumer him/herself, and compiled into a profile by a third party. In the present invention however, rather than associating these profiles with personal identifiers, which presently may be done via “cookies” left on the users computers or the like, they could be associated only with each consumer's voice print. Then, it would be possible for a merchant receiving a call from an individual to have a voice print extracted from the voice, transmitted to the marketing firm, associated with that customer's profile by using only the voice print, and then information in the profile could be transmitted to the merchant useful to marketing to that customer during the remainder of the voice communication.

In such a system and method of profiling a user via their voice ID, it should be recognized that other privacy issues are raised. The present invention also provides privacy protection enhancement for consumer profiles containing voice ID information. To defeat the ability to use a voice ID along with possible stored relationships between voice prints made from consumer's normal voices and personally-identifiable information about them, voice processing technology could be used to modify or disguise the consumer's voice during a telephonic conversation, so that a voice print created from the altered voice does not match one created from that person's unaltered voice. The modifications or alterations to the consumer's voice may be done in-vehicle, at a central location, or a combination thereof. It would be possible to use a different or random alteration each time the consumer makes a telephonic voice call, thus making it impossible for a profile to be created using a single altered, but consistent, voice print made from the altered voice. The voice data may be communicated to a central facility, and digitally processed to alter the voice information, such as described above, and then communicated to its intended destination. It is not the intent to distort the voice so that it is difficult to understand, just to alter characteristics which would prevent the derived voice print from being consistent for a given consumer's voice. Using technology to construct voice prints known in the art, it is not usually possible for a person to disguise his/her voice naturally, so some-type of electronic processing may be required to create a-different voice print not relatable to that-consumer's normal voice print. It is also contemplated that instead of altering the voice, a different voice could be substituted, arbitrarily selected, so that multiple contacts from the consumer will bear a wide variety of voice prints. It is further contemplated that instead of altering the voice or substituting a different voice, that non-voice data can be used having the same informational content as the language being conveyed by the consumer in their own voice. The non-voice data has the advantage that it can be used by third party companies that do have voice communication capabilities. Any combinations of two or more of the methods discussed above are also contemplated.

The present invention is also directed to providing systems and methods for enhancing anonymizing geographic data. Techniques similar to those described previously can be used to “fuzzy” the initial and final destinations for any geographic information stored in a consumer profile, whether it uses the consumer's voice print as its sole identifier as described above, or whether it uses other identifiers. This would make it more difficult to determine the identity of a consumer by determining exact travel starting or ending points for any trips captured in the profile. This contrasts with “origin-destination” location data which are otherwise anonymous contain no personally-identifiable information.

The present invention may allow privacy protection services to be provided to a user, either through a dedicated service or through indirect customers using other services or information through other service providers. In addition to removing all personally-identifiable information (caller ID, equipment ID, static IP address, etc.), a digital processing approach at a central facility could be used to alter each customer's voice, so that a different and un-relatable voiceprint would be made from that voice for each call. This can be done in real time, and the call passed along to whatever destination that is appropriate, given the choices made by the customer in initiating the call and during the voice portal session. However, if the customer requests an emergency call, no PII is removed and his/her voice is not altered, and the call is passed on to the appropriate emergency call processing center along with any location information associated with the call. No records are kept of the alterations that were used for a give call, so that a voice profile created from a call by someone cannot be “reverse engineered” back to a normal profile for a customer, and thus used to establish that customer's identity. For a high privacy system, no voice profile is made for any customer, even for purposes of authenticating the caller as a customer, since the stored voice profile associated with PII about the customer could be used to link information from calls to other parties back to the identity of the customer. Such an approach may not be necessary for normal calls, but may be desired for calls to location based service providers. As described previously, the equipment ID can be used to authenticate the caller as a valid customer, and once authenticated, the services appropriate to that customer will be made available and no PII, including the equipment ID, will be communicated along with the voice call, unless it is an emergency call and is then communicated with full PII and location data to an emergency call center.) The database to which information is communicated may contain demographic and preference information provided by customers, plus geographic data anonymized for origin and destination points, and transaction data, for analytical and marketing purposes. In this case, the data is not collected for individuals, but instead, it is anonymous with respect to PII, and can only be used for analysis and marketing based on demographic or other data for defined groups (male, 40-50 years old, etc.). This service level would appeal to customers desiring the highest level of privacy protection, even though any marketing of goods and services to them will be done less precisely than under other possible approaches as will be described.

In another embodiment, the privacy services could be of a different character to allow users access to more specific information based upon their own preferences or activities as provided or ascertained by the service provider. The methods and systems have similarity to the above privacy approach, except that a voice print is made for each customer during each call, after the caller is authenticated by use of equipment ID or the like, and a voice print ID is stored along with the other data from the call in a database. This allows the ability to relate database records to an individual customer by voice print ID, but there are no stored records relating the voice print ID or the voice print itself to an individual. Although the database records are identified by voice print ID, the voice prints themselves are not stored in the records, so no analysis limited to the databases will have access to the voice prints themselves. The advantage of this approach is that it allows anonymous profiles to be constructed for individuals, and used for tailoring electronic commerce services to them more precisely than possible if only data grouped by demographic and other non-individual characteristics are used. These advantages are offset in that although no records are stored relating the voice prints to the individuals and the voice prints themselves will-not be released except as may be required by law, it will be possible for outside parties to obtain both the “fuzzed up” geographic and other data for a given individual, based on their providing samples of the individual's voice, creating a voice print, and then matching it to one of those related to a voice print ID. This level service would appeal to customers desiring better-targeted goods and services being offered to them, who want a high level of privacy protection, and who don't require the highest level of privacy protection. The user can determine the level of privacy protection desired to selectively allow personalized profiles related to a user to be generated for customized marketing and use of location based services.

As previously mentioned, the present invention may provide privacy protection for data transmitted to third parties for any purpose as selected by a user. An embodiment of the present invention comprises a system and method that originates or collects data, a system or method that removes any unique identification tags from the data set, a system or method that adds a new randomly generated identification tag, and a system or method for correlating multiple data sets belonging to the same person. The data generating system may comprise any telematics or other communication system such as a Personal Digital Assistant (PDA), computer system, cellular telephone or other communication device. A data generating system may be associated with a vehicle or other mobile device for example, wherein the system may generate data relating to the location of the vehicle or the like, as well as a variety of other information such as the time of day, operating parameters of the vehicle or any other information relating to the vehicle. Such systems may also allow voice communication to a central facility or the like, and may also accommodate other forms of data such as image data or the like. Once the information is generated and collected, it then is anonymized either by a system in the vehicle, or by a remote system. If the data is anonymized by a remote system, the raw data set may be transmitted to the remote system via a suitable communication system such as a wireless communication system. After the data is collected, it is anonymized by removing any personal identifying information (PII), such as the equipment identification tag that the modem, cellular phone, or other data transmission equipment attaches to the raw data. This PII is used to identify the user of the data transmission service, and can be used to ascertain the identity of the party that generated the data. Once the PII is removed, the invention replaces the equipment identification code with its own randomly generated anonymization code. This anonymization code, as well as the. equipment identification code is stored by the present invention. The collected raw data set may be encrypted prior to sending the data to a first location or prior to being sent to a third party for use, such as in providing location based services to a user. Once the raw data set is encrypted, the attached anonymization code and encrypted raw data are transmitted to a third party for analysis. Upon receipt of the data set and anonymization code, the third party decrypts the collected raw data, and stores the raw decrypted data in a database whereby it is linked to the randomly generated anonymization identification code. Because the third party can only identify the raw data by its assigned anonymization identification code, the third party is unable to determine who or where the raw data originated. As a result, the party that has generated the data is assured that the transmitted data is secure, and cannot be directly related by the third party alone, back to the origination of the data through the PII.

Additionally, the present invention allows raw data sets that are transmitted to a third party to be related together by their randomly assigned anonymization codes using a supplementary code. Thus, when multiple sets of raw data are sent to a third party for analysis or use over a specific period, the PI for each raw data set are replaced by the same randomly generated anonymization code, and a differing supplementary code. The supplementary code may be used to identify when the specific raw data set was transmitted with respect to the other raw data transmissions for a specific period. Additionally, the supplementary code allows the third party to relate multiple raw data transmissions for a variety of purposes, such as accident reconstruction when used in association with a vehicle. By using the supplemental code, the end data analyst can relate events that are embodied in the raw data sets, or provide customized location based services to a user if desired. Subsequent to transmission and use of the data, the randomly generated anonymization code is erased from the data set to prevent linking the data to a user.

The information gathered by the system can include data from a collision warning system or the like such as disclosed by the inventor's co-owned U.S. Pat. No. 6,438,491 and copending U.S. application Ser. No. 09/633,127, both herein incorporated by reference. Related to these systems, the use of radar signal return strength as well as location-related information provides significant advantages for identifying whether stationary objects detected by radar sensors from a mobile machine or vehicle are “normal” or whether they are unusual. They could be unusual due to the fact that there are actually several objects present, at least one of which may not be normally present and is obstructing the mobile machine's or vehicle's forward path. In that case, it is often important to evaluate characteristics of the one or more detected stationary objects, to help improve confidence in the evaluation whether an object may exist in the forward path.

Once a stationary object is detected, its characteristics are compared with those stored in a database, using the location of the mobile machine or vehicle or the calculated location of the detected object(s) to identify the appropriate information in the database. In this way, variances from the normal characteristics for normally-occurring stationary objects as recorded in the database can be identified, for radar signal return strength as well as location-related characteristics and other possible characteristics of interest.

Because seasonal and weather influences can possible affect the strength of the radar signal return from objects, an approach is needed to adjust for such influences. For example, buildup of ice or snow on the vertical surface of an overhead sign could absorb some of the radar signal, resulting in less signal strength being reflected back to the radar sensor than when no such conditions exist.

To adjust for such variations, several approaches are possible, all of which can be considered dynamically adjusting calibration methods. In these methods, any objects with radar signal return strengths which vary in a significant way from that recorded in the reference database for what are believed to be the same objects are identified. To facilitate this process, some objects may be included in the database as “reference markers” such as roadside signs or other objects which are detectable by the radar but far enough from the lane to not be identified as potentially dangerous. When significant variances in signal return strength are detected from objects contained in the reference database, possible including reference markers as well as objects included for other purposes, then it may be inferred that a consistent change in the signal return strengths is due to seasonal, weather, or other effects. If that determination is made, then an adjustment factor is calculated based on the variances in radar signal strength so detected, to use to calibrate the operation of the system for detecting stationary objects. This calibration method is used to adjust the reference values for radar signal return strength retrieved from the reference database for stationary objects, in the process of comparing those reference values to those detected from stationary objects by the radar sensor on the mobile machine or vehicle. This process is designed to identify the effects of seasonal variations, weather, and other causes of temporary changes in “normal” radar signal return strengths, in a dynamic fashion to improve the ability to identify unusual stationary objects for reasons other than effects on radar signal return strength of normally-existing objects contained in the reference database, only due to seasonal, weather, or other temporary effects

Although the present invention has been described above in detail, the same is by way of illustration and example only and is not to be taken as a limitation on the present invention. It is contemplated that modifications and changes can be made without departing from the scope of the present invention. Accordingly, the scope and content of the present invention are to be defined only by the terms of the appended claims.

What is claimed is:

1. A method for protecting the privacy of data communicated from a mobile system comprising the following steps:
aquiring at least one data element from the mobile system having personal identification information;
removing any personal identification information from the at least one data element;
transferring the at least one data element via wireless communications to at least one receiver not located on the mobile system.

2. A method of monitoring operation of a vehicle or its driver comprising the steps of:
communicating at least one data element from at least one data generating system associated with said vehicle to a service provider;
generating information relating to an operating state of a vehicle, the status of the driver, location of vehicle or an action of said driver during a selected period; and
removing any personal identification information from the generated information and transfering the information to at least one third party.

3. A system for protecting the privacy of data communicated from a mobile system comprising:
a communications system in association with the mobile system, the communications system being coupled to at least one data generating system associated with the mobile system to receive at least one data element;
wherein the communications system is operated to selectively transmit the at least one data element from the communications system to a processing system, wherein the processing system removes personal identification information from the at least one data element, wherein the processed information is transmitted to at least one supplier of a product or service.

4. A system for offering products or services to a vehicle owner comprising:
a communications system in association with the vehicle, the communications system being coupled to at least one data generating system associated with the vehicle to receive at least one data element selected from the group consisting of an operating state of the vehicle, status of the driver, location of the vehicle, an action of the driver during a selected period, external environment, a voice input, or combinations thereof,
the communications system operated to selectively remove personal identification information and to selectively transmit the at least one data element from said communications system to a processing system, the processing system generating information relating to a product or service using the at least one data element, wherein the information is selectively communicated to the owner of the vehicle or at least one supplier of the product or service.
